(19) United States
(12) Patent Application Publication
(10) Pub. No.: US 2011/0154612 A1
(43) Pub. Date: Jun. 30, 2011

(54) HINGE

(75) Inventor: JUNG-BIN CHANG, Tu-Cheng (TW)

(73) Assignee: HON HAI PRECISION INDUSTRY CO., LTD., Tu-Cheng (TW)

(21) Appl. No.: 12/647,408

(22) Filed: Dec. 25, 2009

(51) Int. Cl. E05D 11/00

(52) U.S. Cl. 16/273

(57) ABSTRACT

A hinge includes a first leaf, a pivot shaft mounted to the first leaf, a first knuckle rotatably mounted to the shaft, a second leaf rotatably mounted to the shaft, a resilient assembly mounted to the shaft, and a fastener fixed to the shaft. One end of the first knuckle forms an engaging portion, and the second leaf correspondingly forms a tab to engage with the engaging portion. Upon the condition that the tab engages with the engaging portion such that the first knuckle can rotate with the second leaf, a larger twisting force is needed for the second leaf, together with the first knuckle, to rotate relative to the pivot shaft due to further overcome a friction between the first knuckle and the pivot shaft.

### CROSS-REFERENCE TO RELATED APPLICATION

A relevant subject matter is disclosed in a co-pending U.S. patent application (Attorney Docket No. US30358) filed on the same date and entitled “HINGE,” which is assigned to the same assignee as this patent application.

### BACKGROUND

1. Technical Field

The present disclosure relates to a hinge.

2. Description of Related Art

A foldable device, such as a notebook computer, or a foldable mobile phone, generally includes a base and a cover pivotably mounted to the base via a hinge. The hinge generally includes a pivot shaft, a first leaf, and a second leaf. The first leaf is mounted to the base, and the second leaf is mounted to the cover. A twisting force is required to overcome a friction between the second leaf and the pivot shaft to rotate the cover relative to the base. However, the friction between the second leaf and the pivot shaft remains the same when the device is unfolded. The twisting force required also remains the same, which gives a user an uneasy feeling.

### BRIEF DESCRIPTION OF THE DRAWINGS

FIG. 1 is an exploded, isometric view of a first exemplary embodiment of a hinge.

FIG. 2 is similar to FIG. 1, but viewed from another perspective

FIG. 3 is an assembled, isometric view of the hinge of FIG. 2.

FIG. 4 is similar to FIG. 3, but showing a different state.

FIG. 5 is an exploded, isometric view of a second exemplary embodiment of a hinge.

FIG. 6 is similar to FIG. 4, but viewed from another perspective.

FIG. 7 is an assembled, isometric view of the hinge of FIG. 6.

FIG. 8 is similar to FIG. 7, but showing a different state.

### DETAILED DESCRIPTION

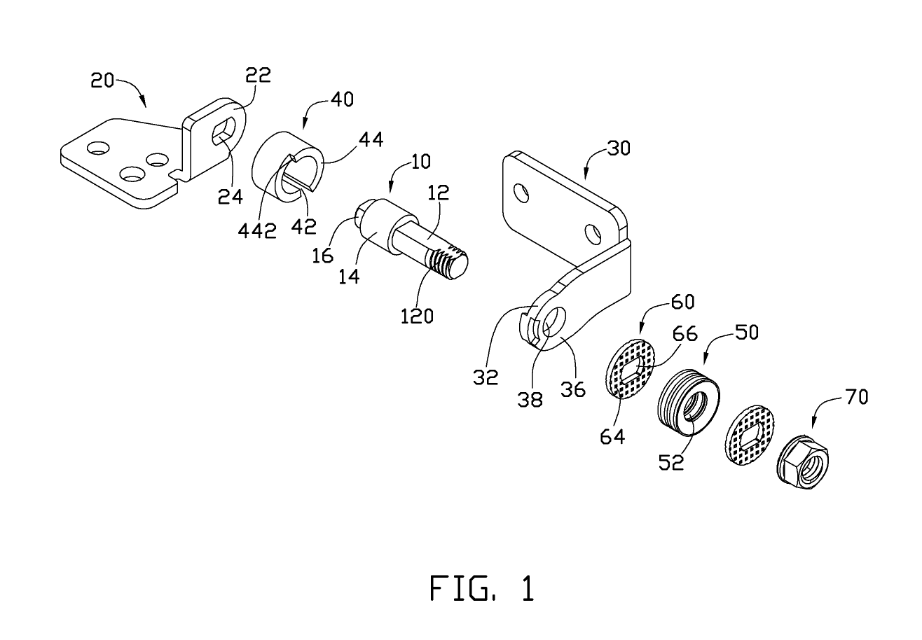

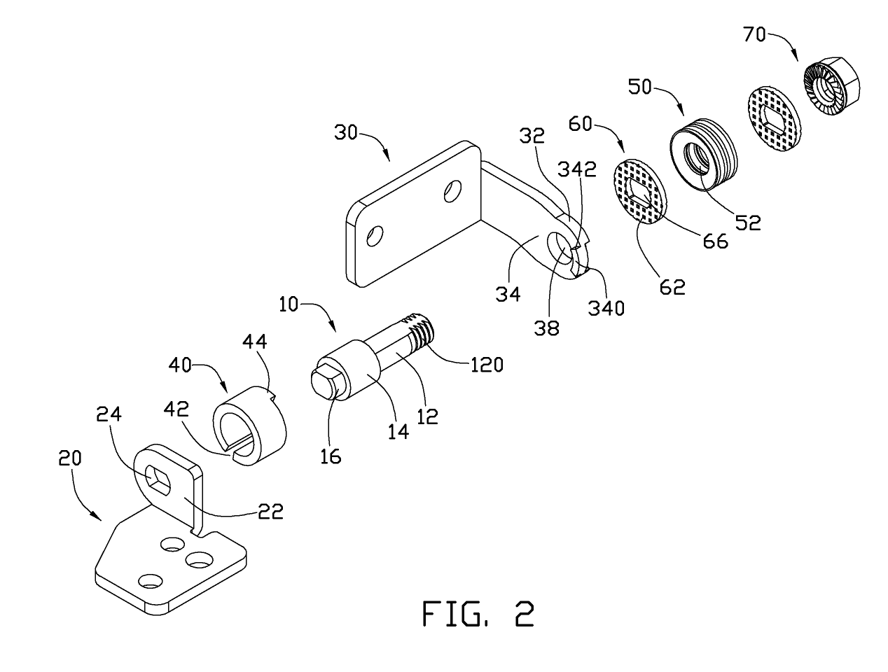

Referring to FIGS. 1 and 2, a first exemplary embodiment of a hinge includes a pivot shaft 10, a first leaf 20, a second leaf 30, a first knuckle 40, a resilient assembly 50, two washers 60, and a fastener 70.

The pivot shaft 10 includes a fixing rod 12 having a substantially non-circular cross-section. A first end of the fixing rod 12 forms a threaded portion 120, and a second end of the fixing rod 12 opposite to the first end forms a non-circular combination block 16. A cylindrical flange 14 extends between the non-circular combination block 16 and the fixing rod 12.

The first leaf 20 is fixed to a base of a foldable device (not shown), such as a notebook computer, and includes a combination portion 22. The combination portion 22 defines a non-circular fixing hole 24 corresponding to the non-circular combination block 16.

The second leaf 30 is fixed to a cover of the foldable device, and includes a second knuckle 32. The second knuckle 32 includes a first end surface 34 facing the first knuckle 40, and a second end surface 36 opposite to the first end surface 34. A round through hole 38 is defined in a center of the second knuckle 32. The fixing rod 12 of the pivot shaft 10 extends through the round through hole 38. A tab 340 extends from a side of the first end surface 34. The tab 340 may be arc-shaped. Two engaging surfaces 342 are formed on opposite ends of the tab 340.

The first knuckle 40 fits about the cylindrical flange 14. The first knuckle 40 defines an incision 42 parallel with an axial direction of the first knuckle 40. An engaging portion 44 is formed on a first end of the first knuckle 40, extending from the incision 42, facing the second knuckle 32. The engaging portion 44 is corresponding to the tab 340. Two engaging surfaces 442 are formed on opposite ends of the engaging portion 44.

The resilient assembly 50 includes a plurality of elastic elements stacked together. Each elastic elements defines a round through hole 52 through which the fixing rod 12 extends.

Each washer 60 includes a first end surface 62 facing the second knuckle 32 of the second leaf 30, and a second end surface 64 opposite to the first end surface 62. A non-circular through hole 66 is defined in a center of the washer 60. The through hole 66 is through the first end surface 62 and the second surface 64. The fixing rod 12 extends through the through hole 66.

In one embodiment, the fastener 70 is a screw cap.

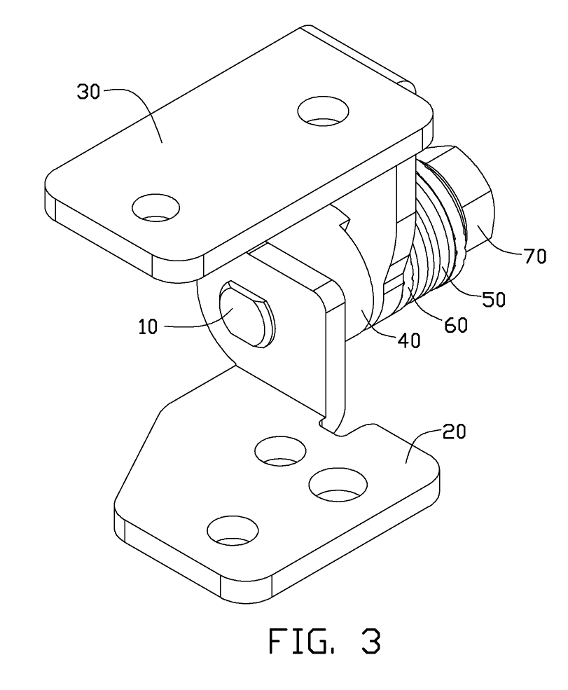

Referring to FIG. 3, during assembly, the combination block 16 is received and fixed in the fixing hole 24. The first knuckle 40, the second leaf 30, one washer 60, the plurality of elastic elements of the resilient assembly 50, and the other washer 60 are sleeved on the pivot shaft 10 in that order. The first knuckle 40 fits about the cylindrical flange 14. The first end surface 34 engages an end of the cylindrical flange 14. The fastener 70 engages with the threaded portion 120, thus fixing the fastener 70 to the pivot shaft 10, to prevent the washers 60, the resilient assembly 50, the second leaf 30, and the first knuckle 40 from disengaging from the pivot shaft 10.

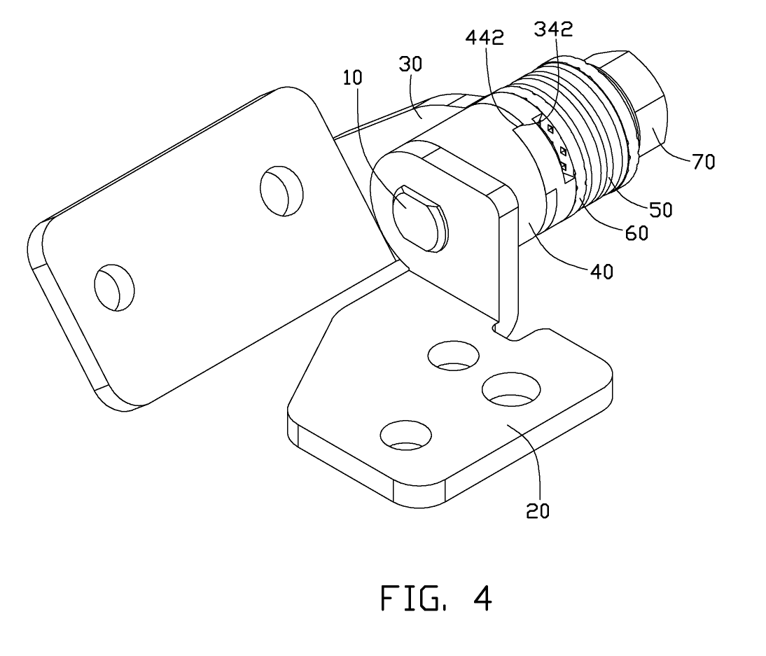

Referring to FIG. 4, to open the foldable device from a folded/closed state, initially, a twisting force f1 is required to overcome a friction between the second end surface 36 and the first end surface 62 of the washer 60, a friction between the second leaf 30 and the fixing rod 12, and a friction between the first end surface 34 and the cylindrical flange 14, to rotate the second leaf 30 relative to the pivot shaft 10. When one of the engaging surfaces 342 of the second leaf 30 engages one of the engaging surfaces 442 of the first knuckle 40, a twisting force f2 is required to simultaneously rotate the second leaf 30 and the first knuckle 40 relative to the pivot shaft 10. Obviously, the twisting force f2 further overcomes a friction between the first knuckle 40 and the cylindrical flange 14. Therefore, the twisting force f2 is larger than the twisting force f1.

To close the foldable device from a unfolded/opened state, initially, the twisting force f1 is required to rotate the second leaf 30 relative to the pivot shaft 10. When the other engaging surface 342 of the second leaf 30 engages the other engaging surface 442 of the first knuckle 40, the twisting force f2 is required to simultaneously rotate the second leaf 30 and the first knuckle 40 relative to the pivot shaft 10.

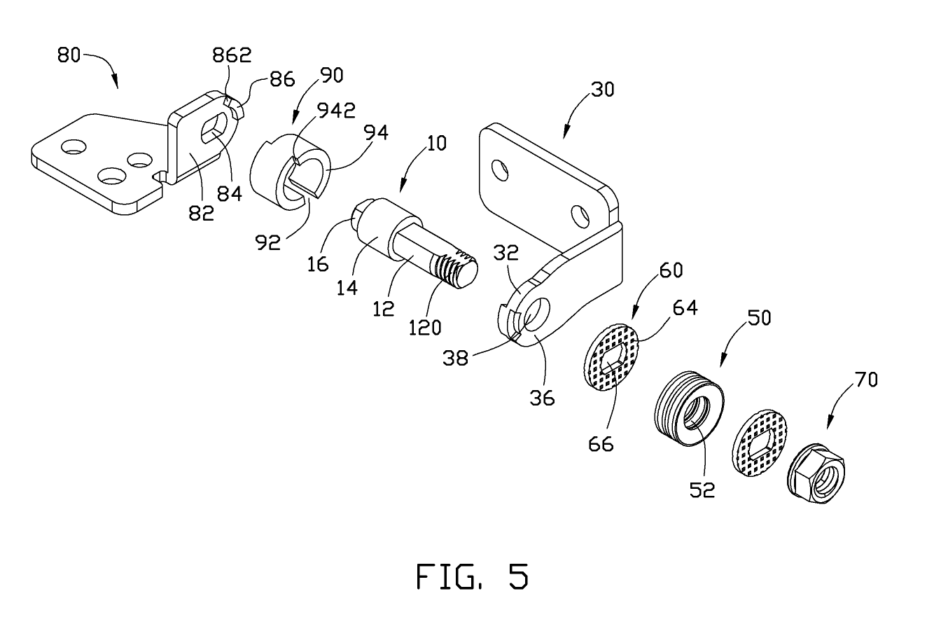

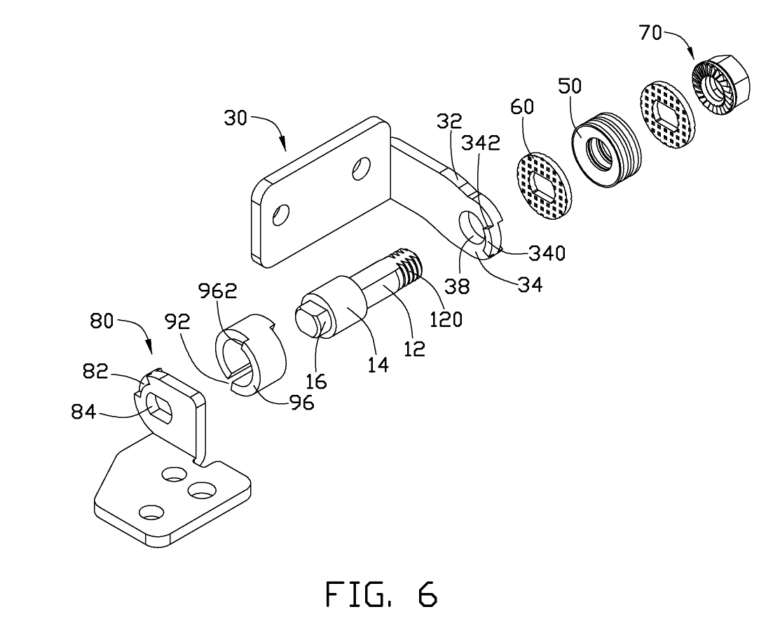

Referring to the FIGS. 5 and 6, a second exemplary embodiment of a hinge includes a first leaf 80 and a first knuckle 90. Other structures of the second exemplary embodiment of the hinge are similar to the first exemplary embodiment of the hinge.

The first leaf 80 is fixed to the base of the foldable device, and includes a combination portion 82. The combination portion 82 defines a non-circular hole fixing hole 84, corresponding to the non-circular combination block 16. A positioning portion 86 extends from a side of the combination portion 82, facing to the first knuckle 90. The positioning portion 86 is arc-shaped. Two positioning surfaces 862 are formed on opposite ends of the positioning portion 86.

The first knuckle 90 fits about the cylindrical flange 14. The first knuckle 90 defines an incision 92 parallel with an axial direction of the first knuckle 90. An engaging portion 94 and an blocking portion 96 are staggeredly formed on two opposite ends of the first knuckle 90, reversely extending from the incision 92. The engaging portion 94 is corresponding to the tab 340. The blocking portion 96 is corresponding to the positioning portion 86. The engaging portion 94 faces the second knuckle 32. The blocking portion 96 faces the combination portion 82. Two engaging surfaces 942 are formed on opposite ends of the engaging portion 94. Two blocking surfaces 962 are formed on opposite ends of the blocking portion 96.

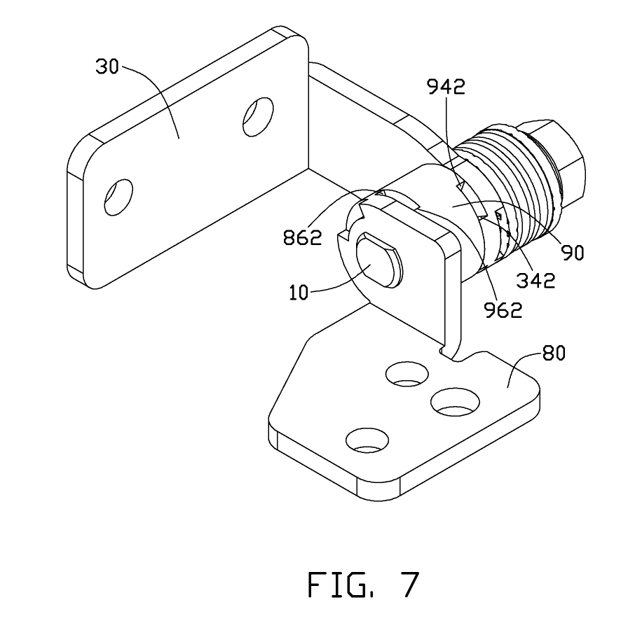

Referring to FIG. 7, during assembly, the combination block 16 is received and fixed in the fixing hole 84. The first knuckle 90, the second leaf 30, one washer 60, the plurality of elastic elements of the resilient assembly 50, and the other washer 60 is sleeved on the pivot shaft 10 in that order. The first knuckle 90 fits about the cylindrical flange 14. The first end surface 34 of the second leaf 30 engages an end of the cylindrical flange 14. The fastener 70 engages with the threaded portion 120 of the pivot shaft 10, thus fixing the fastener 70 to the pivot shaft 10, to prevent the washers 60, the resilient assembly 50, the second leaf 30, and the first knuckle 90 from disengaging from the pivot shaft 10.

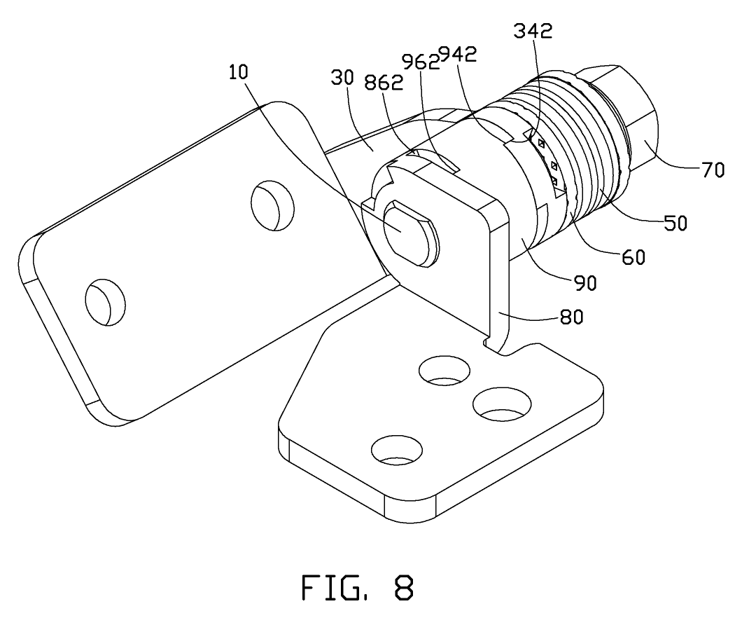

Referring to FIG. 8, to open the foldable device from a folded/closed state, initially, a twisting force f3 is required to overcome a friction between the second end surface 36 and the first end surface 62 of the washer 60, a friction between the second leaf 30 and the fixing rod 12, and a friction between the first end surface 34 and the cylindrical flange 14, to rotate the second leaf 30 relative to the pivot shaft 10. When one of the engaging surfaces 342 of the bracket 30 engages one of the engaging surfaces 942 of the first knuckle 90, a twisting force f4 is required to simultaneously rotate the second leaf 30 and the first knuckle 90 relative to the pivot shaft 10. Obviously, the twisting force f4 further overcomes a friction between the first knuckle 90 and the cylindrical flange 14. The twisting force f4 is larger than the twisting force f3. When one of the blocking surfaces 962 engages with one of the positioning surfaces 862 of the first leaf 80, the first leaf 80 prevents the second leaf 30 and the first knuckle 90 from simultaneously rotating relative to the pivot shaft 10.

To close the foldable device from a unfolded/opened, initially, the twisting force f3 is required to rotate the second leaf 30 relative to the pivot shaft 10. When the other engaging surface 342 of the bracket 30 engages the other engaging surface 942 of the first knuckle 90, the twisting force f4 is required to simultaneously rotate the second leaf 30 and the first knuckle 90 relative to the pivot shaft 10.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A hinge comprising,
a first leaf;
a pivot shaft fixedly mounted to the first leaf;
a first knuckle rotatably mounted to the shaft;
a second leaf rotatably mounted to the shaft;
a resilient assembly mounted to the shaft; and
a fastener fixed to the pivot shaft, wherein one end of the first knuckle forms an engaging portion, the second leaf correspondingly forms a tab to engage with the engaging portion, and wherein upon the condition that the tab engages with the engaging portion such that the first knuckle can rotate with the second leaf, a larger twisting force is needed for the second leaf, together with the first knuckle, to rotate relative to the pivot shaft due to further overcome a friction between the first knuckle and the pivot shaft.

2. The hinge of claim 1, wherein two ends of the engaging portion of the first knuckle respectively forms an engaging surface, correspondingly two ends of the tab of the second leaf respectively forms an engaging surface to engage with a corresponding engaging surface of the engaging portion.

3. The hinge of claim 1, wherein the second leaf comprises a second knuckle, the second knuckle comprises a first end surface facing the first knuckle, the tab is formed on the first end surface.

4. The hinge of claim 3, wherein the pivot shaft comprises a flange protruding from a circumference of the shaft, the first knuckle is rotatably fitted about the flange, and the first end surface of the second leaf is engagable with the flange.

5. The hinge of claim 3, wherein the second knuckle of the second leaf defines a through hole through which the pivot shaft extends.

6. The hinge of claim 1, wherein the first knuckle axially defines an incision, the engaging portion is formed on a first end of the first knuckle and extends from the incision.

7. The hinge of claim 6, wherein a blocking portion is formed on a second end of the first knuckle and extends from the incision, facing the first leaf, the first leaf comprises a combination portion, a positioning portion correspondingly extends from the combination portion of the first leaf to engage with the blocking portion of the first knuckle.

8. The hinge of claim 7, wherein two ends of the blocking portion of the first knuckle respectively forms a blocking surface, correspondingly two ends of the positioning portion of the first leaf respectively forms a positioning surface to engage with a corresponding blocking surface of the blocking portion of the first knuckle.

9. The hinge of claim 7, wherein the pivot shaft comprises a combination block, the combination portion of the first leaf defines a fixing hole, to receive the combination block of the shaft.

10. The hinge of claim 1, wherein the resilient assembly comprises a plurality of elastic elements stacked together, and each of the plurality of elastic elements defines a through hole through which the pivot shaft extends.
